(19) United States
(12) Patent Application Publication
(10) Pub. No.: US 2026/0164281 A1
(43) Pub. Date: Jun. 11, 2026

(54) METHODS, DEVICES, AND SYSTEMS FOR ENHANCING COVERAGE

(71) Applicant: ZTE CORPORATION, Shenzhen (CN)

(72) Inventors: Junfeng ZHANG, Shenzhen (CN); Xing LIU, Shenzhen (CN); Xianghui HAN, Shenzhen (CN)

(21) Appl. No.: 19/123,941

(22) PCT Filed: Apr. 6, 2023
(86) PCT No.: PCT/CN2023/086715

§ 371 Date: Apr. 24, 2025

(51) Int. Cl. H04W 24/10; H04B 17/318; H04W 52/36; H04W 72/1268; H04W 72/21; H04W 72/232; H04W 74/0833

(52) U.S. Cl. CPC H04W 24/10; H04B 17/328; H04W 52/365; H04W 72/1268; H04W 72/21; H04W 72/232; H04W 74/0833

(57) ABSTRACT

Methods, system, and devices for enhancing coverage. The method may include transmitting, by a user equipment (UE) to a base station, a first physical uplink shared channel (PUSCH) with a first waveform; transmitting, by the UE to a base station, a second PUSCH with a second waveform according to an indication of waveform switching; in response to the waveform switching, triggering, by the UE, a power related measurement report based on the second waveform; and transmitting, by the UE, the power related measurement report to the base station in a next uplink transmission.

### CROSS-REFERENCE TO RELATED APPLICATION

This application is a national stage filing under 35 U.S.C. § 371 of international application number PCT/CN2023/086715, filed Apr. 6, 2023. The contents of this application is incorporated herein by reference in its entirety.

### TECHNICAL FIELD

The present disclosure is directed generally to wireless communications. Particularly, the present disclosure relates to methods, devices, and systems for enhancing coverage.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In mobile communication networks, e.g., NR (New Radio), the requirement of larger coverage of cell in the initial access procedure and connected state should be satisfied. Physical random access channel (PRACH) repetition may be one of the ways to enhance the coverage of PRACH during one of first steps of initial access. Dynamic waveform switching may be another way to enhance the coverage of physical uplink shared channel (PUSCH). There are some issues/problems associated with these methods, particularly some issues/problems associated with how to integrate them to work together to enhance coverage with high efficiency.

The present disclosure describes various embodiments for enhancing coverage, addressing at least one of the issues/problems discussed above and advancing the wireless communication technology.

### SUMMARY

This document relates to methods, systems, and devices for wireless communication, and more specifically, for enhancing coverage. The various embodiments in the present disclosure may include new method for enhancing coverage, which is beneficial to improve coverage ranges between base stations and user equipments, to increase the resource utilization efficiency, and to boost performance of the wireless communication.

In one embodiment, the present disclosure describes a method for wireless communication. The method may include transmitting, by a user equipment (UE) to a base station, a first physical uplink shared channel (PUSCH) with a first waveform; transmitting, by the UE to a base station, a second PUSCH with a second waveform according to an indication of waveform switching; in response to the waveform switching, triggering, by the UE, a power related measurement report based on the second waveform; and transmitting, by the UE, the power related measurement report to the base station in a next uplink transmission.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium may be a non-transitory computer-readable medium.

The above and other aspects and their implementations are described in greater detail in the drawings, the descriptions, and the claims.

### BRIEF DESCRIPTION OF DRAWINGS

FIG. 1A shows an example of a wireless communication system include one wireless network node and one or more user equipment.

FIG. 1B shows a schematic diagram of various coverages.

FIG. 2 shows an example of a network node.

FIG. 3 shows an example of a user equipment.

FIG. 4 shows a flow diagram of a method for wireless communication.

FIG. 5 shows a schematic diagram of an exemplary embodiment for wireless communication.

FIG. 6 shows a schematic diagram of another exemplary embodiment for wireless communication.

FIG. 7 shows a schematic diagram of another exemplary embodiment for wireless communication.

FIG. 8 shows a schematic diagram of another exemplary embodiment for wireless communication.

FIG. 9 shows a schematic diagram of another exemplary embodiment for wireless communication.

FIG. 10 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for enhancing coverage.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

New radio (NR) has introduced a basic scheme to support the initial access under at least two frequency range (FR): FR1 (sub 6G Hz band) and FR2 (beyond 6G Hz band). The scheme includes different physical random access channel (PRACH) formats, PRACH resource configurations, relationship between synchronization signal block (SSB) and PRACH, mechanism of PRACH retransmission, mechanism of PRACH power control, etc.

In some implementations for coverage enhancement, PRACH repetition may be used to further enhance the coverage in initial access procedure. There are some issues/problems associated with this approach, for example, one issue is that, when the supplementary uplink carrier (SUL) random access channel (RACH) is involved in the PRACH repetition, SUL RACH is RACH transmission in the supplementary uplink carrier.

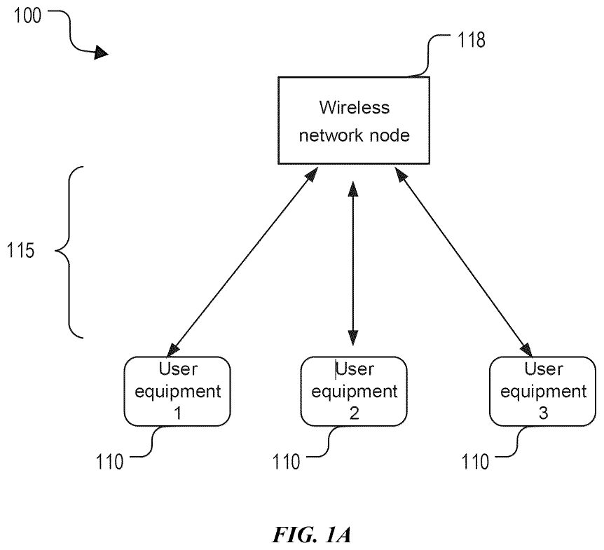

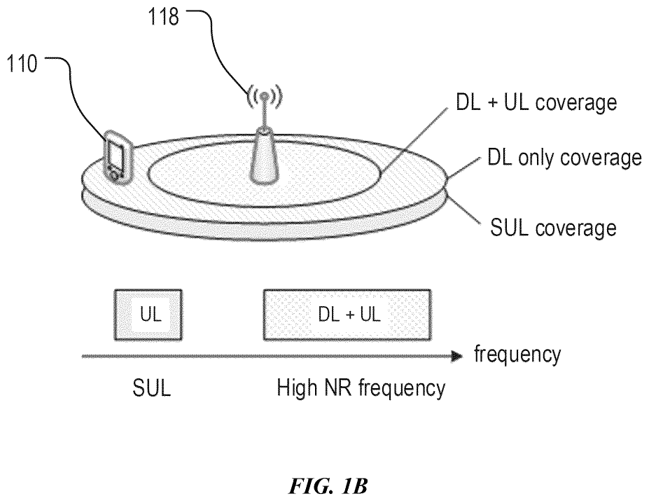

In some implementations, SUL means there are two uplink (UL) carriers (SUL and NR UL (NUL)) and one downlink (DL) in one cell. In some implementations, there is no simultaneous uplink transmissions in SUL and NUL. Normally, the NUL is transmitted in the higher frequency band and SUL is transmitted in the lower frequency band, the coverage for SUL is better than the coverage for NUL, as shown in FIG. 1B. Therefore, one benefit of SUL is for the uplink coverage enhancement especially when a UE 110 locates in the cell edge of a wireless network node 118.

In some implementations for coverage enhancement, waveform switching (e.g., dynamic waveform switching) may be used to further enhance the coverage for physical uplink shared channel (PUSCH) especially for downlink control information (DCI) scheduled PUSCH. In some implementations, using a waveform means that cyclic prefix orthogonal frequency division multiplexing (CP-OFDM) waveform or a direct Fourier transform spread OFDM (DFT-S-OFDM or DFT-s OFDM) waveform is applied to the DL or UL channel. Normally, a peak-to-average power ratio (PAPR) or cubic metric (CM) value of CP-OFDM is higher than DFT-s OFDM, it means the channel applied DFT-s OFDM may have higher actually power efficiency. But the channel applied DFT-s OFDM is less flexible on frequency domain resource allocation than the channel applied CP-OFDM. The tradeoff between power efficiency and flexibility of resource allocation may be considered when selecting which waveform of the CP-OFDM or DFT-s OFDM waveform is applied.

In some implementations, for a UE at a cell edge, DFT-s OFDM waveform is preferred. For a UE at a cell center, CP-OFDM waveform is preferred.

In some implementations for some systems, the waveform of channel is configured by RRC signaling and the switching of waveform is very slow. In order to quick response the requirement of waveform switching, the dynamic waveform switching based on DCI indication in different scenarios is beneficial for the power efficiency and flexibility of resource allocation. One or more bits for dynamic waveform switching is appended or inserted in the DCI to indicate the waveform determined by base station in time. There are some issues/problems associated with these implementations with the waveform determination in case of bandwidth part (BWP) switching, or in case of carrier switching. For example, one issue/problem may include how to design the indication bit(s) in case of one DCI scheduling multiple PUSCH; and/or how to report the assistant information on a power headroom (PHR), or a maximum power in a cell (Pcmax).

The present disclosure describes various embodiments of methods for enhancing coverage, addressing at least one if the issues/problems discussed above.

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message. In some implementations, the wireless network node may be referred as a wireless node, and the UE may be referred as a wireless device.

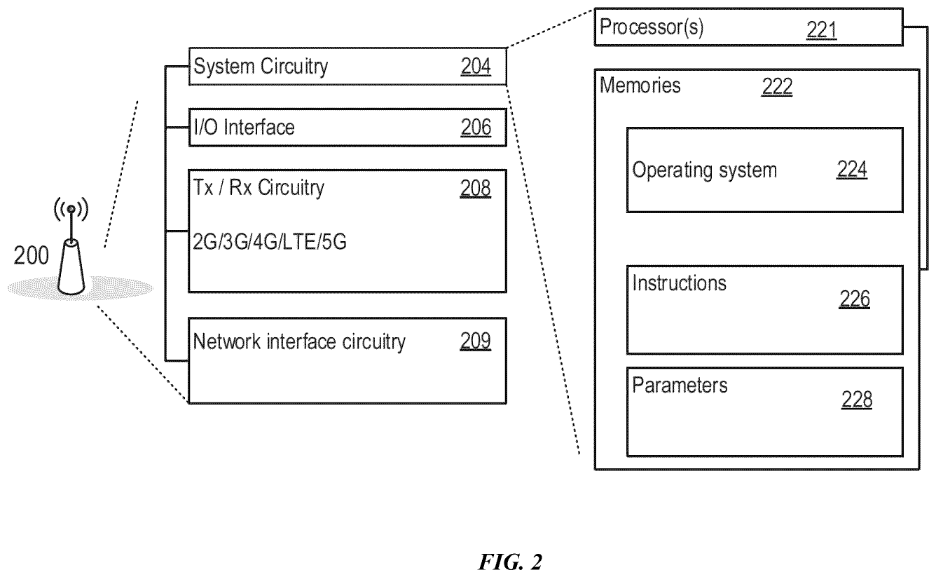

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

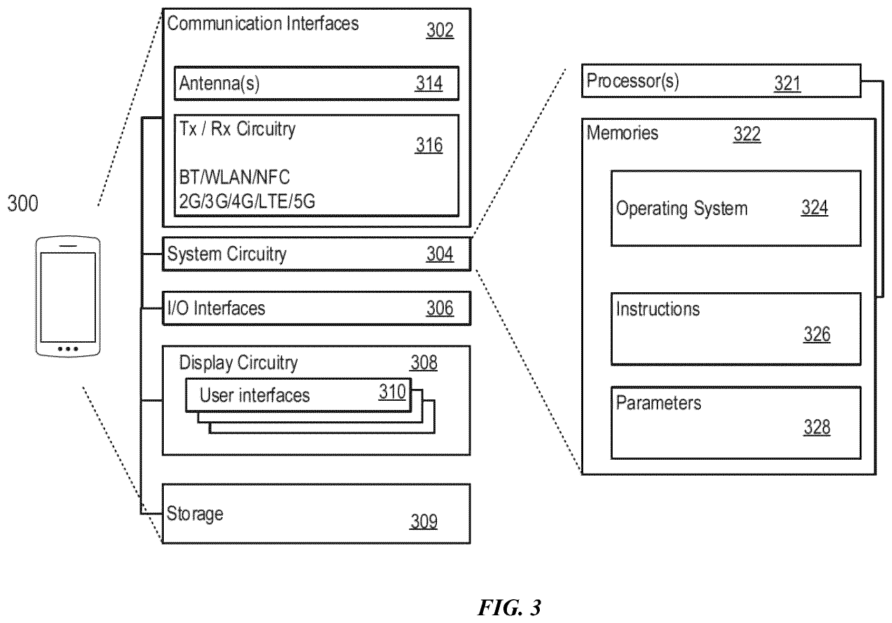

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for enhancing coverage, which may be implemented, partly or totally, on the network base station and/or the user equipment described above in FIGS. 2-3. The various embodiments in the present disclosure may increase the resource utilization efficiency and boost performance of wireless communication.

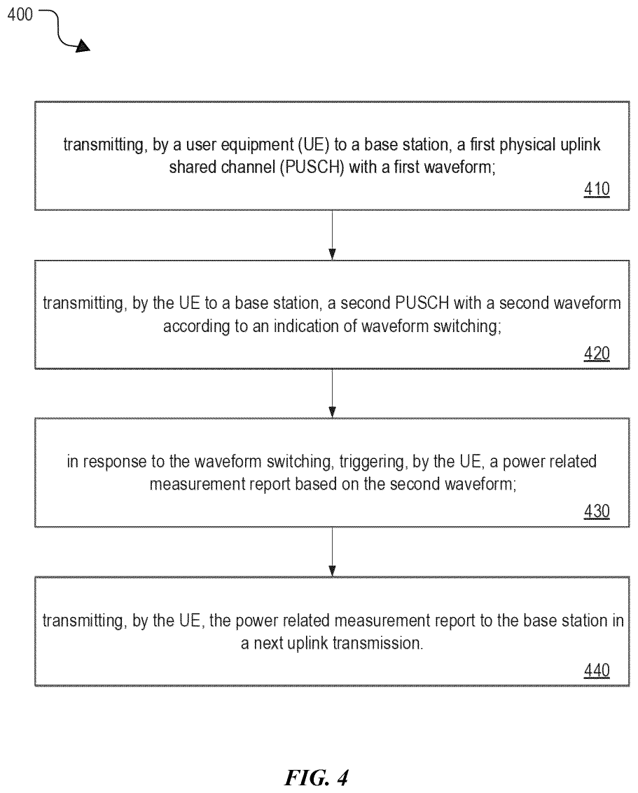

Referring to FIG. 4, the present disclosure describes various embodiments of a method 400 for wireless communication. The method may include a portion or all of the following steps: step 410, transmitting, by a user equipment (UE) to a base station, a first physical uplink shared channel (PUSCH) with a first waveform; step 420, transmitting, by the UE to a base station, a second PUSCH with a second waveform according to an indication of waveform switching; step 430, in response to the waveform switching, triggering, by the UE, a power related measurement report based on the second waveform; and/or step 440, transmitting, by the UE, the power related measurement report to the base station in a next uplink transmission. In some implementations, the waveform switching may be referred to as dynamic waveform switching.

In some implementations, the power related measurement report comprises at least one of the following: a power headroom report (PHR), and/or a maximum power in a cell (Pcmax) report.

In some implementations, the second waveform is different from the first waveform, each of which comprises a cyclic prefix orthogonal frequency division multiplexing (CP-OFDM) waveform or a direct Fourier transform spread OFDM (DFT-S-OFDM) waveform.

In some implementations, the method 400 may further include one or more of the following steps: receiving, by the UE, a downlink control information (DCI) from the base station, the DCI scheduling N transport blocks (TBs), N being a positive integer; and wherein the DCI comprises N bits indicating dynamic waveform switching for the N TBs, each of the N bits indicating the dynamic waveform switching for each of the N TBs.

In some implementations, the method 400 may further include one or more of the following steps: receiving, by the UE, a DCI from the base station, the DCI scheduling N TBs, N being a positive integer; and wherein the DCI comprises M bits indicating dynamic waveform switching for a first subset of the N TBs, M being a positive integer and smaller than N.

In some implementations, the first subset comprises M TBs that are capable of performing the dynamic waveform switching; and/or each bit of the M bits indicates the dynamic waveform switching for each TB of the first subset.

In some implementations, remaining TBs in the N TBs other than the first subset comprises (N-M) TBs that are incapable of performing the dynamic waveform switching.

In some implementations, the method 400 may further include one or more of the following steps: receiving, by the UE, a DCI from the base station, the DCI scheduling N TBs, N being a positive integer; and wherein the DCI comprises one bit indicating dynamic waveform switching for the N TBs, and the bit is determined based on a waveform for a majority TBs in the N TBs.

In some implementations, the method 400 may further include one or more of the following steps: receiving, by the UE, a DCI from the base station, the DCI scheduling N TBs, N being a positive integer; and wherein the DCI comprises a single bit indicating dynamic waveform switching for the N TBs, and the single bit is determined based on a default waveform.

In some implementations, in response to the UE switching from a source bandwidth part (BWP) to a target BWP, both of which support dynamic waveform switching: an indicated waveform by a DCI scheduling the source BWP is still valid for a scheduled PUSCH in the target BWP; or the indicated waveform by the DCI scheduling the source BWP is ignored and a default waveform configured by a radio resource control (RRC) is used for the scheduled PUSCH in the target BWP.

In some implementations, the default waveform configured by the RRC is to the source BWP or the target BWP.

In some implementations, in response to the UE switching from a source bandwidth part (BWP) to a target BWP, and only the target BWP supporting dynamic waveform switching: a waveform configured by a RRC to the target BWP is used for a scheduled PUSCH in the target BWP.

In some implementations, in response to the UE switching from a source bandwidth part (BWP) to a target BWP, and only the source BWP supporting dynamic waveform switching: an indicated waveform by a DCI scheduling the source BWP is ignored and a waveform configured by a RRC to the target BWP is used for a scheduled PUSCH in the target BWP.

In some implementations, the method 400 may further include one or more of the following steps: in response to multiple physical random access channel (PRACH) transmissions being configured in a supplementary uplink (SUL): determining, by the UE based on a signal power measurement, whether a PRACH transmission is transmitted in a new radio uplink (NUL) or the SUL; and/or in response to determining that the PRACH transmission is transmitted on the SUL, determining a transmission level of the PRACH transmission in the SUL.

In some implementations, the method 400 may further include one or more of the following steps: in response to multiple physical random access channel (PRACH) transmissions being configured in a supplementary uplink (SUL): determining, by the UE based on a signal power measurement according to a set of thresholds, whether a PRACH transmission is transmitted in a new radio uplink (NUL) or the SUL, and a transmission level of the PRACH transmission.

In some implementations, the signal power measurement comprises a synchronization signal block (SSB) reference signal received power (RSRP); and/or the level of the PRACH transmission indicates a repetition number of PRACH transmission.

The present disclosure describes various embodiments for enhancing coverage, which may include the following implementations, and which may serve as non-limiting examples.

### Embodiment Set I: PRACH Repetition in SUL

In some implementations, the NR supports PRACH to be initialized in the SUL carrier. A parameter (e.g., rsrp-ThresholdSSB-SUL) is for a UE to determine whether to initialize the PRACH in a SUL carrier. In some implementations, there is no reason to prohibit the multiple PRACH transmissions in the SUL carrier. Generally, the SUL carrier is in the lower frequency band than the carrier of a NUL in the higher frequency band, the PRACH in SUL is helpful to the coverage enhancement of PRACH.

In some implementations, when multiple PRACH transmission is configured in the SUL, the multiple PRACH transmission may be triggered in the SUL when the measurement of synchronization signal block (SSB) reference signal received power (RSRP) is satisfied with the rsrp-ThresholdSSB-SUL and thresholds for multiple PRACH transmission in SUL.

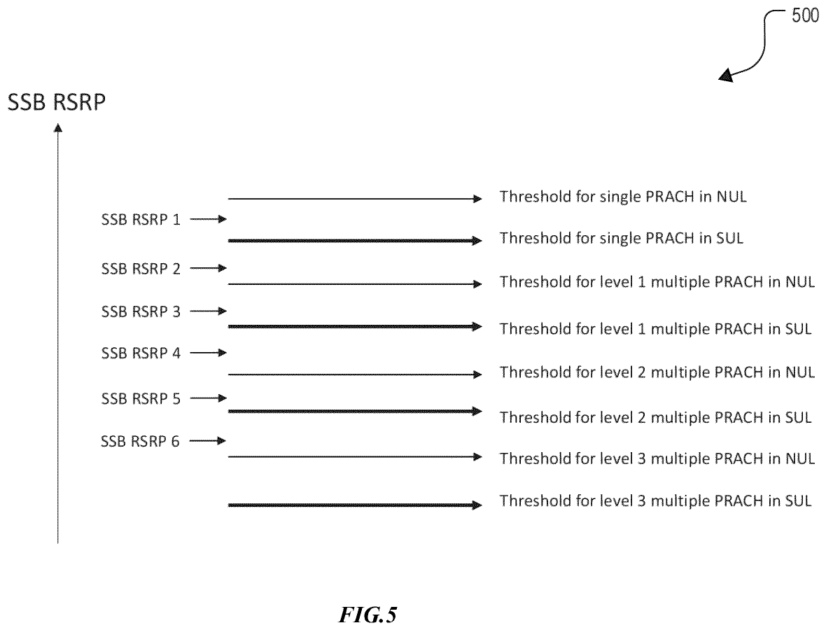

In some implementations, referring to FIG. 5, there may be a threshold for single PRACH in NUL and a threshold for single PRACH in SUL. There are also thresholds for multiple level of multiple PRACH in NUL or SUL. The typical relative positions of all the thresholds 500 are shown in FIG. 5, which also shows determination of multiple PRACH in NUL or SUL.

In some implementations, there may be two alternative methods for determining whether a single PRACH or a multiple PRACH is selected and/or determining whether the selected PRACH is on a NUL or a SUL based on the measurement of SSB RSRP and comparison between the measurement and thresholds.

One method (Alternative 1) may include determining whether a PRACH is on the NUL or the SUL firstly and then determining whether the single PRACH or the multiple PRACH, and then determine the level for multiple PRACH in the SUL, if needed.

For non-limiting examples, referring to FIG. 5, in case of SSB RSRP 1, its RSRP is lower than the threshold for the single PRACH in the NUL but higher than the threshold for the single PRACH in the SUL, and thus, the single PRACH in the NUL will be triggered. In case of SSB RSRP 2, its RSRP is lower than the threshold for the single PRACH in the SUL but higher than the threshold for the multiple PRACH with level 1 in the NUL, and thus, the single PRACH in SUL will be triggered. In case of SSB RSRP 3, as the principle is to determine the PRACH on NUL or SUL first, its RSRP is lower than the threshold for the single PRACH in the SUL but higher than the threshold for the multiple PRACH with level 1 in the SUL, and thus, the single PRACH in the SUL is triggered. For the same reason, in case of SSB RSRP 4, the multiple PRACH with level 1 in SUL is triggered. In case of SSB RSRP 5, the multiple PRACH with level 1 in SUL is triggered too. In case of SSB RSRP 6, the multiple PRACH with level 2 in SUL is triggered.

In some implementations, the multiple PRACH with level 1 refers to the PRACH repetition number is 2; the multiple PRACH with level 2 refers to the PRACH repetition number is 4; and the multiple PRACH with level 3 refers to the PRACH repetition number is 8.

The other method (Alternative 2) may include that there is no need to firstly determine whether PRACH on NUL or SUL; but directly comparing the measurement of SSB RSRP and the thresholds to determine single or multiple PRACH in NUL or SUL, and further determining the level for multiple PRACH in NUL or SUL, if needed.

For non-limiting examples, referring to FIG. 5, in case of SSB RSRP 1, its RSRP is lower than the threshold for the single PRACH in NUL but higher than the threshold for the single PRACH in SUL, and thus, the single PRACH in NUL will be triggered. In case of SSB RSRP 2, its RSRP is lower than the threshold for the single PRACH in SUL but higher than the threshold for the multiple PRACH with level 1 in NUL, and thus, single PRACH in SUL will be triggered. In case of SSB RSRP 3, its RSRP is lower than the threshold for the multiple PRACH with level 1 in NUL but higher than the threshold for the multiple PRACH with level 1 in SUL, and thus, multiple PRACH with level 1 in NUL is triggered. In case of SSB RSRP 4, its RSRP is lower than the threshold for multiple PRACH with level 1 in SUL but higher than the threshold for the multiple PRACH with level 2 in NUL, and thus, the multiple PRACH with level 1 in SUL is triggered. For the same reason as above, in case of SSB RSRP 5, the multiple PRACH with level 2 in NUL is triggered. In case of SSB RSRP 6, the multiple PRACH with level 2 in SUL is triggered.

One benefit of the Alternative 1 is that it can keep the backward compatibility with previous procedure of determination whether NUL or SUL firstly; and one issue is that it may lose the chance of the multiple PRACH transmissions in NUL when the RSRP is lower than the threshold for the single PRACH in SUL.

One benefit of the Alternative 2 is the approach can efficiently use the multiple PRACH transmissions in NUL; and one issue is that it may change the legacy behavior of decision on NUL or SUL.

In various embodiments, when multiple PRACH transmission is configured in the SUL, an exemplary method may include determining whether a PRACH transmission is on NUL or SUL firstly, then determining whether the single PRACH or the multiple PRACH is used, and then determining the level for multiple PRACH in SUL, if needed.

In various embodiments, another exemplary method may include, without firstly determining whether a PRACH transmission is on NUL or SUL, directly comparing the measurement of SSB RSRP and the thresholds to determine single or multiple PRACH in NUL or SUL, and then determining the level for multiple PRACH in NUL or SUL, if needed.

### Embodiment Set II: Waveform Switching with BWP/Carrier Switching

In various embodiments, a waveform of CP-OFDM or DFT-s OFDM is applied to a transmission channel. Dynamic waveform switching means that the waveform of CP-OFDM or DFT-s OFDM is indicated in the DCI scheduling the correspondence PUSCH, the scheduled PUSCH will apply the indicated waveform. In ideal situation without any other limitations or restrictions, the waveform of current PUSCH may be different with the waveform of next scheduled PUSCH.

In some implementations, although all the channels in a bandwidth part (BWP) may support the semi-static waveform indication through a radio resource control (RRC) signaling, not all the BWP have the capability to support the dynamic waveform switching. Under such circumstances, the present disclosure describes three cases for waveform switching when a UE is switching between a source BWP and a target BWP.

The first case (Case 1) may include that the dynamic waveform switching is supported by the source BWP and the target BWP.

When the UE switches from the source BWP to the target BWP, and when there is an indication of waveform in the DCI scheduling in the source BWP but the scheduled PUSCH is in the target BWP, a portion or all of the following various methods/approaches may be used for determining the waveform of the scheduled PUSCH in the target BWP.

For one method (Alternative 1), the indication of waveform in the DCI scheduling in the source BWP is still valid for the scheduled PUSCH in target BWP. This approach inherits the indication in the DCI seamlessly when the BWP switching happens. The risk is that the waveform indicated in the source BWP may not be suitable for the actually transmission in the target BWP as a power headroom of the UE or a pathloss measured in different BWPs may not be same.

For another method (Alternative 2), the indication in the DCI scheduling in the source BWP is ignored when the UE switches to the target BWP. The waveform configured to the target BWP by the RRC signaling is applied to the scheduled PUSCH. This approach is safer to the UE, and the UE will determine the waveform until the UE is in the stable situation after the BWP switching.

For another method (Alternative 3), the indication in the DCI scheduling in the source BWP is ignored when the UE switches to the target BWP. The waveform configured to the source BWP by the RRC signaling is applied to the scheduled PUSCH.

For another method (Alternative 4), the indication in the DCI scheduling in the source BWP is ignored when the UE switches to the target BWP. The default waveform configured by a new RRC parameter is applied to the scheduled PUSCH. The new RRC parameter for a default waveform can be configured as the waveform for the source BWP or for the target BWP. This approach combines Alternative 2 and 3 and keeps the flexibility of configuration.

The second case (Case 2) may include that the dynamic waveform switching is supported only by the target BWP, but not by the source BWP

When the dynamic waveform switching is not supported in the source BWP, it means that there is no indication field in the DCI for waveform switching, although dynamic waveform switching is supported in the target BWP, the waveform applied to the scheduled PUSCH in target BWP can only be set as the waveform configured to the target BWP by a RRC signaling or a default waveform configured by a RRC signaling.

In some implementations, another case may include that the dynamic waveform switching is not supported in the source BWP but supported in another BWP in the same cell. The indication field in the DCI for the waveform switching may also be supported for the source BWP without capability of dynamic waveform switching, and then similar operations as Case 1 may follow.

The third case (Case 3) may include that the dynamic waveform switching is supported only by the source BWP or the other BWP in the same cell, but not by the target BWP.

When the dynamic waveform switching is not supported in the target BWP, it means the indication field in the DCI scheduling in the source BWP for waveform switching cannot be supported by the target BWP, the only approach is that the UE may ignore the indication field in the DCI scheduling in the source BWP and apply the waveform configured to the target BWP by a RRC signaling or a default waveform configured by a RRC.

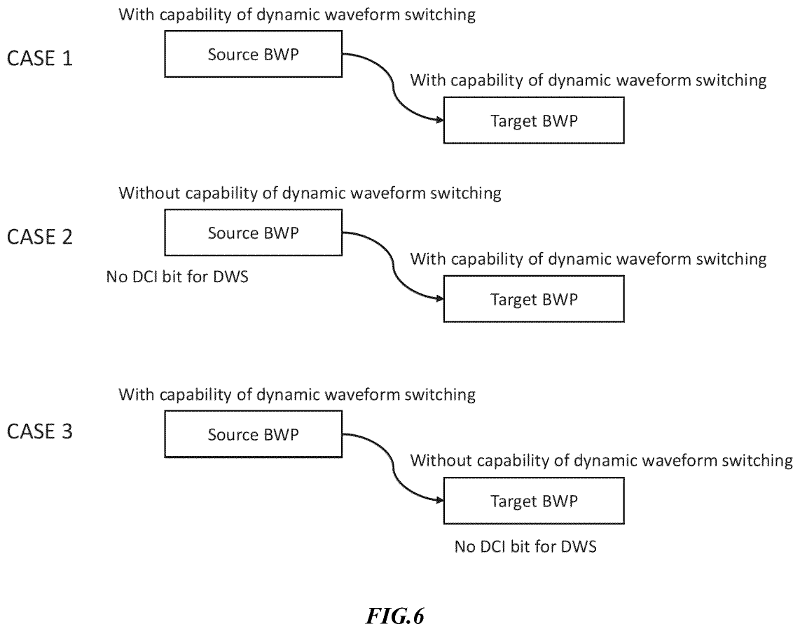

FIG. 6 shows a schematic diagram of waveform determination when BWP is switching, wherein DWS denotes dynamic waveform switching.

In various embodiments when a UE is switching between a source carrier and a target carrier, the principle of determination of a waveform is similar with the UE switching between a source BWP and a target BWP with replacing carrier with BWP.

In some implementations, when the source carrier and target carrier are under cross carrier scheduling (i.e., one carrier is a scheduling carrier and the other carrier is a scheduled carrier), and the capabilities of supporting dynamic waveform switching are different for the scheduling carrier and the scheduled carrier (e.g., dynamic waveform switching is supported by the scheduling carrier but not by the scheduled carrier, or vice versa), a DCI size may be aligned between the cross carrier scheduling and self-scheduling when the same DCI formats are used, i.e., there may be dynamic waveform switching field in the DCI for cross carrier scheduling and self-scheduling.

Referring to FIG. 6, for Case 1, the dynamic waveform switching is supported by the source BWP and the target BWP. The indication of waveform in the DCI scheduling in the source BWP is still valid for the scheduled PUSCH in the target BWP. Or, the indication in DCI scheduling in the source BWP is ignored when the UE switches to the target BWP. The default waveform configured by a new RRC parameter is applied to the scheduled PUSCH. The new RRC parameter for a default waveform can be configured as the waveform for the source BWP or for the target BWP. For Case 2, the dynamic waveform switching is supported only by the target BWP, but not by the source BWP. The waveform applied to the scheduled PUSCH in the target BWP can only be set as the waveform configured to the target BWP by the RRC signaling. For Case 3, the dynamic waveform switching is supported only by the source BWP or the other BWP in the same cell, but not by the target BWP. The UE ignores the indication field in the DCI scheduling in the source BWP and applies the waveform configured to the target BWP by the RRC signaling.

### Embodiment Set III: Dynamic Waveform Switching with One DCI Scheduling Multiple Transport Blocks

In some implementations, one bit for dynamic waveform indication in a DCI is enough for the case of one DCI scheduling one transport block (TB).

The present disclosure describes various embodiments for determining a number of bits of indication for the case of one DCI scheduling multiple TBs. One DCI scheduling multiple TBs may include several scenarios: multiple PUSCH carrying multiple TBs are scheduled in different time, in different frequency, or in different uplink transmitting/receiving points (TRPs). It is beneficial that for different TBs scheduled by one DCI, the waveform of the PUSCHs carrying different TBs may be indicated separately, especially in the scenario of different uplink TRPs, as the wireless environment, radio frequency (RF) character of different TRPs may vary a lot.

In some implementations, when a maximum supported uplink TBs scheduled by one DCI is specified as N, wherein N being a positive integer, at most N bits in DCI field may be specified to support the waveform indication for the TBs up to N. The least significant bit (LSB) of N bits correspondences the smallest index of PUSCH in all the PUSCHs. When some PUSCHs in some carriers/BWPs/TRPs do not support dynamic waveform switching, and only M (M<N) PUSCHs support dynamic waveform switching, the indication may be M bits, wherein M being a positive integer, and each bit correspondences each PUSCH which supports the dynamic waveform switching.

In some implementations, to keep the backward compatibility, one waveform indication bit for multiple TBs scheduled by one DCI may be applied but it may negatively affect the performance of uplink transmission due to unsuitable waveform applied.

In some implementations, a simple method may be used to compensate the performance loss. When the scheduler thinks a specific waveform is intended for no less than

$$⌈ \frac{N}{2} ⌉$$

TBs, or when the majority waveform among TBs which support dynamic waveform switching, the dynamic waveform indication may be set as the specific waveform. With this method, one bit of indication is enough for majority TBs.

In the present disclosure, ┌x┐ refers to a ceiling function whose result is the least integer greater than or equal to x.

In some implementations, another method is to use the conservative waveform. For example, DFT-s OFDM is more conservative for the coverage enhancement, or CP-OFDM is more conservative for the UEs supporting Type 0 frequency domain resource allocation (not all the UEs support Type 0). With this method, one bit of indication is used to indicate the conservative waveform.

In some implementations, another method is to use a default waveform (e.g., DFT-s OFDM). With this method, one bit of indication is used to indicate the default waveform.

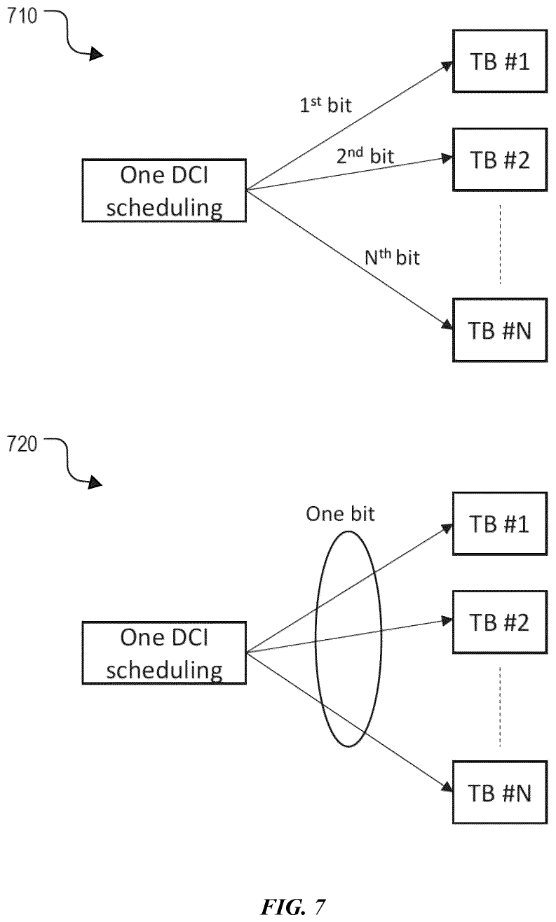

FIG. 7 shows schematic diagrams of using N or 1 bit(s) waveform indication for one DCI scheduling multiple TBs. For 710, at most N bits in DCI is to indicate the dynamic waveform switching for N PUSCH carrying N multiple TBs scheduled by one DCI; and for 720, only one bit in DCI is to indicate the dynamic waveform switching for N PUSCH carrying N multiple TBs scheduled by one DCI. The bit is determined on the waveform of majority TBs or the specific waveform applied for no less than

$$⌈ \frac{N}{2} ⌉$$

### TBs.

### Embodiment Set IV: Assistant Information Report when Dynamic Waveform Switching is Applied

In some implementations, to help a base station to configure the waveform for future PUSCH transmission more accurately and more timely, a UE may report assistant information of power headroom (PHR) or a maximum power in a cell (Pcmax) or other possible report based on the estimation or calculation on the PUSCH possibly scheduled in future.

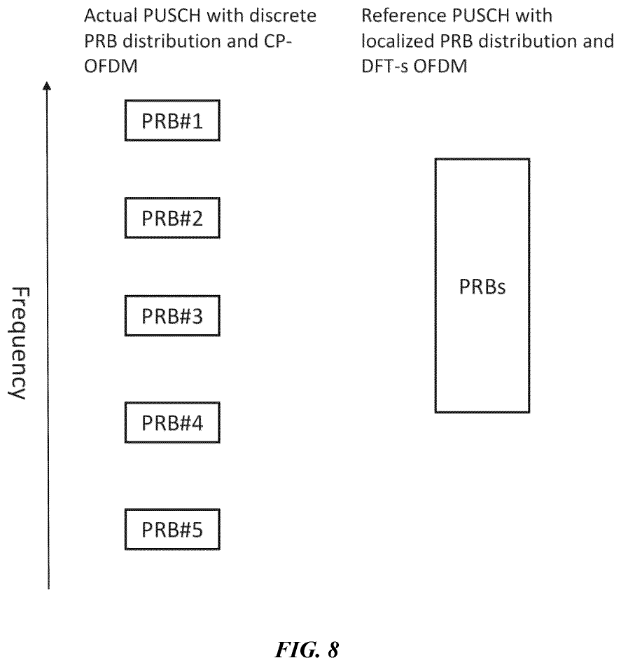

In some implementations, a current PUSCH transmission is defined as an actually PUSCH and a PUSCH scheduled in future can be defined as a reference PUSCH. When PRBs used by the actually PUSCH and the reference PUSCH are the same, it is easy to predict or estimate the PHR or Pcmax or other possible parameters. When PRBs used by the actually PUSCH and reference PUSCH are different, it is hard to predict or estimate the results for assistant information report. For example, when the Type 0 PRB allocation and CP-OFDM waveform are applied to actual PUSCH, the frequency domain resources are discrete distribution, but the Type 1 PRB allocation and DFT-s OFDM waveform are applied to reference PUSCH, the frequency domain resources are localized distribution, various method may be used to predict or estimate the PHR or Pcmax based on the current PRBs. For example, one method may include predicting or estimating based on the PRBs of actual PUSCH overlapping with reference PUSCH, e.g., PRB #2, #3, #4 in FIG. 8, but it is still not accurate as the frequency resources are different. FIG. 8 shows a schematic diagram of different PRBs used by actual PUSCH and reference PUSCH.

It is better to trigger the PHR or Pcmax report based on switched waveform after the waveform of PUSCH has been switched. The reference PUSCH and actual PUSCH are merged into the current PUSCH after waveform switching and the scheduling information, such as MCS, frequency domain resources, etc., are same for reference PUSCH and actual PUSCH. The estimation of PHR or Pcmax or other report will be carried in the subsequent PUSCH.

In some implementations, this approach may not predict PHR or Pcmax before or on the time of waveform switching, but only report the PHR or Pcmax based on the switched waveform after the waveform switching. In some implementations, it may be untimely to reflect the assistant information about PHR or Pcmax of the PUSCH before scheduling. The benefit is to keep the backward compatibility of legacy PHR report mechanism as much as possible and to save the overhead of UL signaling. In some implementations, it is also helpful to avoid the problem of different PRBs used by actual PUSCH and reference PUSCH mentioned above.

In some implementations, although the PHR or Pcmax is reported after waveform switching, the base station may also have the capability to roughly estimate the difference of PHR between DFT-s-OFDM and CP-OFDM without the additional report of power headroom related information before waveform switching. When the UE finishes the waveform switching based on the indication from the base station, the PHR after waveform switching may be reported to base station to verify the rough PHR estimation in the base station, and the base station can decide to keep the switched waveform or fallback to original waveform. The base station can also change the scheduled PRB or modulation and coding scheme (MCS) to adapt the reported PHR. Through a mass of data of a history PHR report, the smart and self-learning base station has the capability to store the history PHR data of different waveform, different RB allocated, and/or different modulation order, and further to adaptively adjust the algorithm for the estimation of a future PHR before waveform switching.

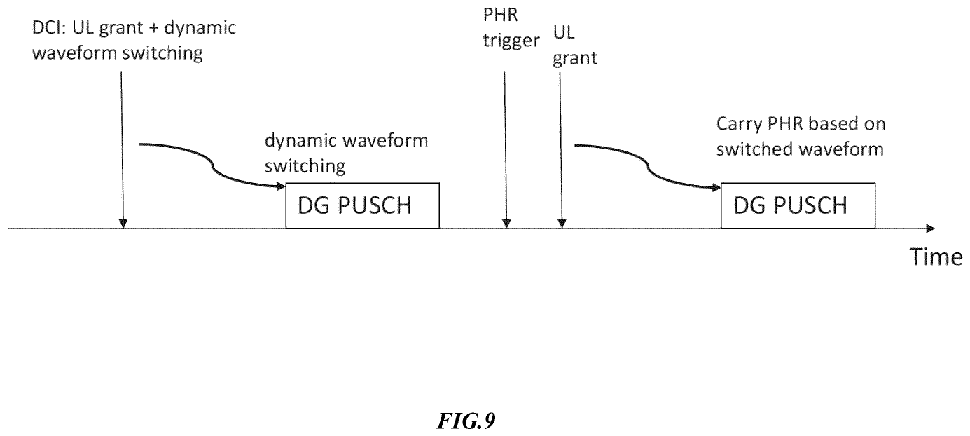

FIG. 9 shows a schematic diagram of PHR report after waveform switching

In some implementations, to quickly report the PHR or Pcmax after waveform switching, it is encouraged for a UE to trigger the PHR or Pcmax report as soon as possible after the waveform switching. The PHR is estimate based on the switched waveform, but not the waveform configured by a RRC signaling, i.e., the UE may bypass the waveform configured by the RRC signaling when dynamic waveform switching is configured or activated.

In various embodiments, the PHR is based on the waveform after dynamic waveform switching, but not the waveform configured by the RRC signaling, i.e., the indication from the RRC signaling is overlaid by the real-time waveform. In some implementations for another trigger mechanism: the PHR is triggered after the waveform switching as soon as possible, and the PHR may be carried in the next uplink transmission after waveform switching.

### Embodiment Set V: CORESET and/or Search Space Design for Multiple PRACH Transmissions

In some implementations, for a four-step random access procedure, the random access and contention resolution functions need to be finished in four complete steps before the RRC link is established. The four steps may include the following. In Step 1: a terminal (UE) sends a preamble on a random access channel (RACH) occasion (RO). In Step 2: a base station sends a random access response (i.e., Msg2) to the UE. In Step 3: the UE sends Msg3 to the base station. In Step 4: the base station sends contention resolution. The procedure not only applies to the single PRACH transmission but also to the multiple PRACH transmissions.

In some implementations, during Step 2, the Msg2 PDCCH for random access response may be scrambled by a Random Access Radio Network Temporary Identifier (RA-RNTI). The RA-RNTI associated with the PRACH occasion in which the random access preamble is transmitted, is computed as: RA-RNTI=1+s_id+14×t_id+14×80×f_id+14×80×8×ul_carrier_id, wherein s_id is the index of the first OFDM symbol of the PRACH occasion (0≤s_id<14), t_id is the index of the first slot of the PRACH occasion in a system frame (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

In some implementations, the UE descrambles the Msg2 PDCCH for random access response (RAR) by RA-RNTI and decode the Msg2 PDSCH addressed by Msg2 PDCCH to get the RAR content. When the random access preamble ID (RAPID) (Preamble) in the RAR is identified as the same preamble which is sent in step 1, the UL grant in RAR content will guide UE to transmit the Msg3 in step 3.

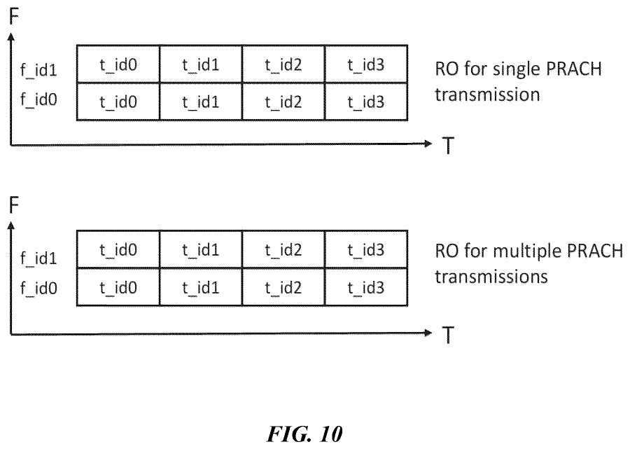

In some implementations, the ROs for single PRACH transmission and the ROs for multiple PRACH transmission are configured individually. But when the ROs for single PRACH transmission and ROs for multiple PRACH transmission have the same f_id and t_id, the RA-RNTIs corresponding to single PRACH transmission and multiple PRACH transmission are the same too, as illustrated in FIG. 10. When the UE uses the RA-RNTI to descramble the Msg2 PDCCH for the RAR, it may get the RAR originally intended to another UE, especially when the preambles used by this UE and another UE are the same, the UE doesn't know the RAR content is mismatched. The ambiguity of the RAR reception would breakdown the whole RACH procedure. FIG. 10 shows a schematic diagram of same RA-RNTI for single and multiple PRACH transmissions, wherein F is frequency and T is time.

In some implementations, to avoid the mismatch of the RAR, the UE may have the ability to differentiate the Msg2 PDCCH for single and multiple PRACH transmissions. The different CORESET and/or search space of Msg2 PDCCH for single and multiple PRACH transmissions can be considered for differentiation.

In some implementations, a control resource set (CORESET) is a group of physical resource set to carry PDCCH which contains some resource blocks (in frequency domain) and some OFDM symbols (in time domain). Basic parameters to describe the CORESET are a location and/or number of RBs and a number of OFDM symbols. Search space for PDCCH describes the time domain characteristic which includes the time domain period, time offset, monitoring slot per period, and/or monitoring starting symbol location in each slot, etc. The combination of CORESET and search space determines the time/frequency resource of PDCCH.

In some implementations, the different CORESET and/or search space of Msg2 PDCCH for single and multiple PRACH transmissions may be specified and informed to the UE in order to differentiate the Msg2 PDCCH for single and multiple PRACH transmissions.

The present disclosure describes methods, apparatus, and computer-readable medium for wireless communication. The present disclosure addressed the issues with enhancing coverage. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a user equipment (UE) to a base station, a first physical uplink shared channel (PUSCH) with a first waveform;
transmitting, by the UE to a base station, a second PUSCH with a second waveform according to an indication of waveform switching;
in response to the waveform switching, triggering, by the UE, a power related measurement report based on the second waveform; and
transmitting, by the UE, the power related measurement report to the base station in a next uplink transmission.

2. The method according to claim 1, wherein:
the power related measurement report comprises at least one of the following:
a power headroom report (PHR), or
a maximum power in a cell (Pcmax) report.

3. The method according to claim 1, wherein:
the second waveform is different from the first waveform, each of which comprises a cyclic prefix orthogonal frequency division multiplexing (CP-OFDM) waveform or a direct Fourier transform spread OFDM (DFT-S-OFDM) waveform.

4. The method according to claim 1, further comprising:
receiving, by the UE, a downlink control information (DCI) from the base station, the DCI scheduling N transport blocks (TBs), N being a positive integer; and wherein
the DCI comprises N bits indicating dynamic waveform switching for the N TBs, each of the N bits indicating the dynamic waveform switching for each of the N TBs.

5. The method according to claim 1, further comprising:
receiving, by the UE, a DCI from the base station, the DCI scheduling N TBs, N being a positive integer; and wherein
the DCI comprises M bits indicating dynamic waveform switching for a first subset of the N TBs, M being a positive integer and smaller than N.

6. The method according to claim 5, wherein:
the first subset comprises M TBs that are capable of performing the dynamic waveform switching; and
each bit of the M bits indicates the dynamic waveform switching for each TB of the first subset.

7. The method according to claim 5, wherein:
remaining TBs in the N TBs other than the first subset comprises (N-M) TBs that are incapable of performing the dynamic waveform switching.

8. The method according to claim 1, further comprising:
receiving, by the UE, a DCI from the base station, the DCI scheduling N TBs, N being a positive integer; and wherein
the DCI comprises one bit indicating dynamic waveform switching for the N TBs, and the bit is determined based on a waveform for a majority TBs in the N TBs.

9. The method according to claim 1, further comprising:
receiving, by the UE, a DCI from the base station, the DCI scheduling N TBs, N being a positive integer; and wherein
the DCI comprises a single bit indicating dynamic waveform switching for the N TBs, and the single bit is determined based on a default waveform.

10. The method according to claim 1, wherein, in response to the UE switching from a source bandwidth part (BWP) to a target BWP, both of which support dynamic waveform switching:
an indicated waveform by a DCI scheduling the source BWP is still valid for a scheduled PUSCH in the target BWP; or
the indicated waveform by the DCI scheduling the source BWP is ignored and a default waveform configured by a radio resource control (RRC) is used for the scheduled PUSCH in the target BWP.

11. The method according to claim 10, wherein:
the default waveform configured by the RRC is to the source BWP or the target BWP.

12. The method according to claim 1, wherein, in response to the UE switching from a source bandwidth part (BWP) to a target BWP, and only the target BWP supporting dynamic waveform switching:
a waveform configured by a RRC to the target BWP is used for a scheduled PUSCH in the target BWP.

13. The method according to claim 1, wherein, in response to the UE switching from a source bandwidth part (BWP) to a target BWP, and only the source BWP supporting dynamic waveform switching:
an indicated waveform by a DCI scheduling the source BWP is ignored and a waveform configured by a RRC to the target BWP is used for a scheduled PUSCH in the target BWP.

14. The method according to claim 1, further comprising:
in response to multiple physical random access channel (PRACH) transmissions being configured in a supplementary uplink (SUL):
determining, by the UE based on a signal power measurement, whether a PRACH transmission is transmitted in a new radio uplink (NUL) or the SUL; and
in response to determining that the PRACH transmission is transmitted on the SUL, determining a transmission level of the PRACH transmission in the SUL.

15. The method according to claim 1, further comprising:
in response to multiple physical random access channel (PRACH) transmissions being configured in a supplementary uplink (SUL):
determining, by the UE based on a signal power measurement according to a set of thresholds, whether a PRACH transmission is transmitted in a new radio uplink (NUL) or the SUL, and a transmission level of the PRACH transmission.

16. The method according to claim 14, wherein:
the signal power measurement comprises a synchronization signal block (SSB) reference signal received power (RSRP); and
the level of the PRACH transmission indicates a repetition number of PRACH transmission.

17. A wireless communications apparatus comprising a processor and a memory, wherein the processor is configured to read code from the memory and implement a method for wireless communication, comprising:
transmitting, by a user equipment (UE) to a base station, a first physical uplink shared channel (PUSCH) with a first waveform;
transmitting, by the UE to a base station, a second PUSCH with a second waveform according to an indication of waveform switching;
in response to the waveform switching, triggering, by the UE, a power related measurement report based on the second waveform; and
transmitting, by the UE, the power related measurement report to the base station in a next uplink transmission.

18. (canceled)

19. A non-transitory computer readable program storage medium having code stored thereon, the code, when executed by a processor, causing the processor to implement a method for wireless communication, comprising:
transmitting, by a user equipment (UE) to a base station, a first physical uplink shared channel (PUSCH) with a first waveform;
transmitting, by the UE to a base station, a second PUSCH with a second waveform according to an indication of waveform switching;
in response to the waveform switching, triggering, by the UE, a power related measurement report based on the second waveform; and
transmitting, by the UE, the power related measurement report to the base station in a next uplink transmission.

20. The method according to claim 15, wherein:
the signal power measurement comprises a synchronization signal block (SSB) reference signal received power (RSRP); and
the level of the PRACH transmission indicates a repetition number of PRACH transmission.
